(19) United States
(12) Patent Application Publication
(10) Pub. No.: US 2018/0035823 A1
(43) Pub. Date: Feb. 8, 2018

(54) MULTI-FEATURE DIAPER BAG

(71) Applicant: KRISTEN EMILY LANDEROS, SANTA BARBARA, CA (US)

(72) Inventor: KRISTEN EMILY LANDEROS, SANTA BARBARA, CA (US)

(21) Appl. No.: 15/667,582

(22) Filed: Aug. 2, 2017

Related U.S. Application Data
(60) Provisional application No. 62/494,335, filed on Aug. 3, 2016.

(51) Int. Cl. A47D 13/02; A45C 11/24; G06K 19/073; A45C 13/10; A45C 15/00; A45C 9/00; A45C 13/00

(52) U.S. Cl. CPC A47D 13/025; A45C 9/00; A45C 11/24; A45C 13/001; A45C 13/10; A45C 15/00; G06K 19/07327; A45C 2013/1015; H02S 40/00

(57) ABSTRACT

A multi-featured diaper bag is described. The bag includes a four-point attachment system to permit attachment of the bag to the should straps and waist strap of a wearable infant carrier. The bag includes one or more closable compartments in which various amenities and accessories can be stored. Conveniently, when in use, the contents of the diaper are accessible to a user without having to remove the infant carrier or detach the bag from the infant carrier.

### PRIORITY CLAIM

This application claims the benefit under 35 U.S.C. § 119(e) of U.S. Provisional Application No. 62/494,335, filed Aug. 3, 2016, and entitled “Combined bag, wallet, diaper bag, and cell phone pouch to attach to baby carrier, stroller, car seat back, and/or person”, the entirety of which is hereby incorporated by reference herein.

### FIELD OF THE INVENTION

This invention relates to diaper bags and similar accessories for use in organizing and transporting items needed for the care of infants.

### BACKGROUND

In modern times, it has become increasingly popular to carry a variety of accessories and/or amenities for use in the care of infants and toddlers. These can include diapers, wipes, changing pads, tissues, lotions, powders, toys, food as well as more items of more general use such as keys, wallets, portable phones and the like.

In some cases, these amenities can be stored on board a baby stroller or carriage freeing the parent or caretaker from the need to carry these items. However, it is common for infant caretakers to transport infants using wearable carriers rather than rollable strollers. An example of this type of carrier is provided in U.S. Patent Publication No. 2014/0014692 (Andren et al.). These wearable carriers are modeled on backpacks, using shoulder straps and a waist band to secure the carrier to the body of the person carrying the infant.

Wearable infant carriers provide several advantages over strollers including portability, and the ability to carry an infant in places where a wheeled stroller would be unmanageable (e.g., rough ground, hiking trails, through water, or areas with mud or deep snow). However, when using wearable infant carriers, the convenience of storage space provided by a stroller is lost. Thus, those amenities that are typically taken along when transporting an infant must be stored and carried in some other way, typically in a traditional diaper bag.

Traditional prior art diaper bags have their own limitations as well. Significantly, prior art diaper bags are typically designed to be carried by hand. The use of such a bag thus occupies the user's hands, rather than having their hands free, foregoing one of the primary advantages of using a wearable carrier. Carrying a diaper bag by hand, the contents of which can have significant weight, is also fatiguing.

There are diaper bags that can be worn. For example, U.S. Pat. No. 8,001,803, describes a diaper bag with heated and cooled compartments that can be worn by a user, much like a backpack. However, this bag suffers from a significant limitation in that it is difficult to wear while also wearing a wearable infant carrier as it is hot and heavy and increases the chances of back strain when worn for extended periods of time. A single user can only carry the infant or the diaper bag, but not both. Thus, this design is unsuitable for an individual who requires the ability to both carry the infant in a wearable carrier along with a diaper bag for amenities and accessories.

### SUMMARY OF THE INVENTION

The present disclosure relates to an improved diaper bag and accessory carrier system that is adapted to be secured to a wearable infant carrier. Unlike prior art bags the present invention provides a bag that has a 4-point attachment system that can be connected to the shoulder straps and waist strap of a wearable infant carrier. The bag is also adapted to be secured to the headrest of a car seat back, and can also be attached to a wheeled stroller, shopping cart and other objects if desired. In some embodiments, the straps can also be configured such that a user can carry the bag by hand.

There is provided in some embodiments, a portable diaper bag comprising: a main body comprising a plurality of compartments, each compartment comprising an opening to permit access to the interior of the compartment: and a four-point attachment system comprising: a top left strap, a top right strap, a bottom left strap and a bottom right strap, wherein the top left and top right straps are positioned on the main body such that they can each be reversibly secured to a shoulder strap of a wearable infant carrier, and wherein the bottom left and bottom right straps are position on the main body such that they can each be reversibly secured to a waist strap on the wearable infant carrier.

In some embodiments, each compartment further comprises a closure mechanism.

In some embodiments, each of the straps in the four-point attachment system comprises a fastener. In some embodiments, the fastener comprises at least one of male and female snaps, male and female slide connectors, and a loop and hook fastening material. In some embodiments, the length of each strap in the four-point attachment system is independently adjustable.

In some embodiments, the diaper bag further comprises at least one loop on the exterior of the main body for attaching objects. In some embodiments, the four-point attachment is configured such that each one of the straps can be fastened to any one of the other straps to form a at least one handle for carrying by hand.

In some embodiments, the bag further comprises a photovoltaic device configured to charge electronic devices.

In some embodiments, the diaper bag is invertible such that the bag can be foldable into one of the compartment for storage.

In some embodiments, the main body comprises a radio frequency opaque material. In some embodiments, the radio frequency material is effective to protect interrogation of an RFID-containing device stored within the diaper bag.

In some embodiments, the bag further comprises a reflective material effective to improve visibility of the bag at night.

In some embodiments, the diaper bag further comprises at least one detachable compartment.

The present disclosure also provides a method of using a portable diaper bag, the method comprising: providing a diaper bag, the diaper bag a main body comprising a plurality of compartments, each compartment comprising an opening to permit access to the interior of the compartment, wherein the diaper bag further comprises a four-point attachment system comprising: a top left strap, a top right strap, a bottom left strap and a bottom right strap, wherein the top left and top right straps are positioned on the main body such that they can each be reversibly secured to a shoulder strap of a wearable infant carrier, and wherein the bottom left and bottom right straps are position on the main body such that they can each be reversibly secured to a waist strap on the wearable infant carrier; providing a wearable infant carrier, the wearable infant carrier having a left shoulder strap, a right shoulder strap and a waist strap having a left portion and a right portion; securing the top left strap to the left shoulder strap, the top right strap to the right shoulder strap, the bottom left strap to the left portion of the waist strap, and the bottom right strap to the right portion of the waist strap; and placing the assembled diaper bag and wearable infant carrier on a user.

### BRIEF DESCRIPTION OF THE DRAWINGS

Preferred embodiments of the present invention are described herein, with reference to the accompanying drawings, in which:

FIG. 1 depicts an embodiment of a diaper bag according to the present disclosure.

FIG. 2 depicts an embodiment of a diaper bag according to the present disclosure, and an example of how it can be attached to a shoulder harness and waist strap style infant carrier.

FIG. 3 depicts an embodiment of a diaper bag according to the present disclosure, and an example of how it can be attached to a shoulder harness and waist strap style infant carrier, and worn by a user.

FIG. 4A depicts an embodiment of an detachable compartment suitable for storing a cell phone or similar device, that can be included with the diaper bag of the present disclosure.

FIG. 4B depicts an embodiment of a clip secured to the inside a closeable compartment, suitable for attaching a key ring or similar accessory.

### DESCRIPTION OF THE INVENTION

The following discussion provides examples of embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed. Those of skill in the art will recognize that the described embodiment are examples of possible configurations of the invention, and are not intended to be limiting to the scope of the invention. Accordingly, the drawings and descriptions contained herein are to be regarded as illustrative of the invention as set forth in the accompanying claims.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

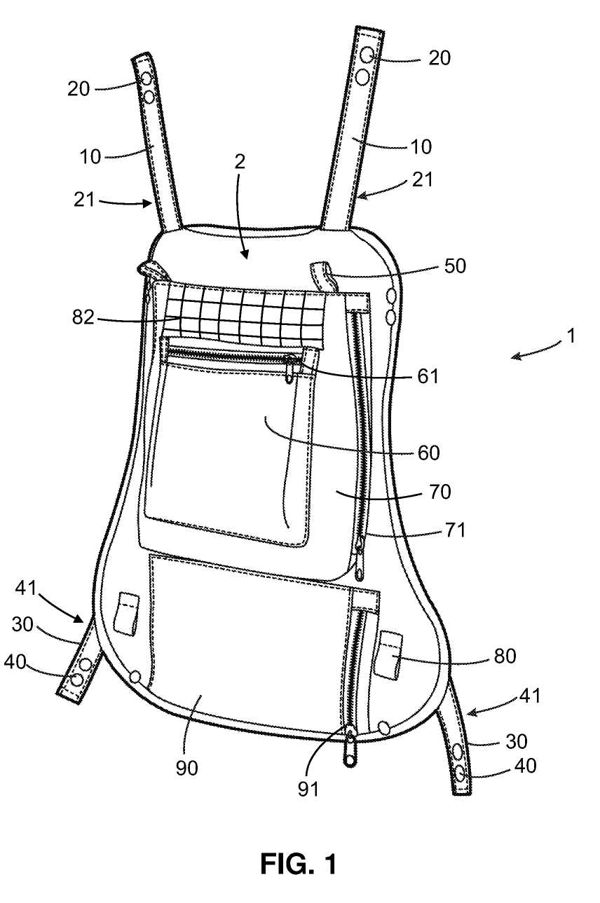

The present disclosure, and FIGS. 1-3 describe preferred embodiments of a multi-featured diaper bag. As shown in FIG. 1, the diaper bag 1 comprises a main body 2 the main body having an exterior surface and a plurality of compartments in which amenities and accessories may be stored. The diaper bag further includes a four-point attachment system, the four-point attachment system comprising top left and top right straps 10, and bottom left and bottom right straps 30 and fasteners 20, 21, 40, 41 for securing to a wearable infant carrier, or for converting the diaper bag into one that can be carried by hand like prior art bags. The top left and top right straps include complimentary fasteners 20, 21. In some embodiments the complimentary fasteners comprise male 20 and female 21 portions of snaps know to those of skill in the art. In other embodiments, the fasteners may comprise hook and loop structure fasteners, or slide style fasteners such as those described in U.S. Pat. No. 7,614,533. Similarly, the bottom left and right straps also comprise complimentary fasteners 40, 41 that function in a similar fashion to those located on the top straps of the diaper bag. As with the top strap fasteners, the bottom strap fasteners may also comprise complimentary male 40 and female 41 snaps, hook and loop structures or slide style fasteners as described above.

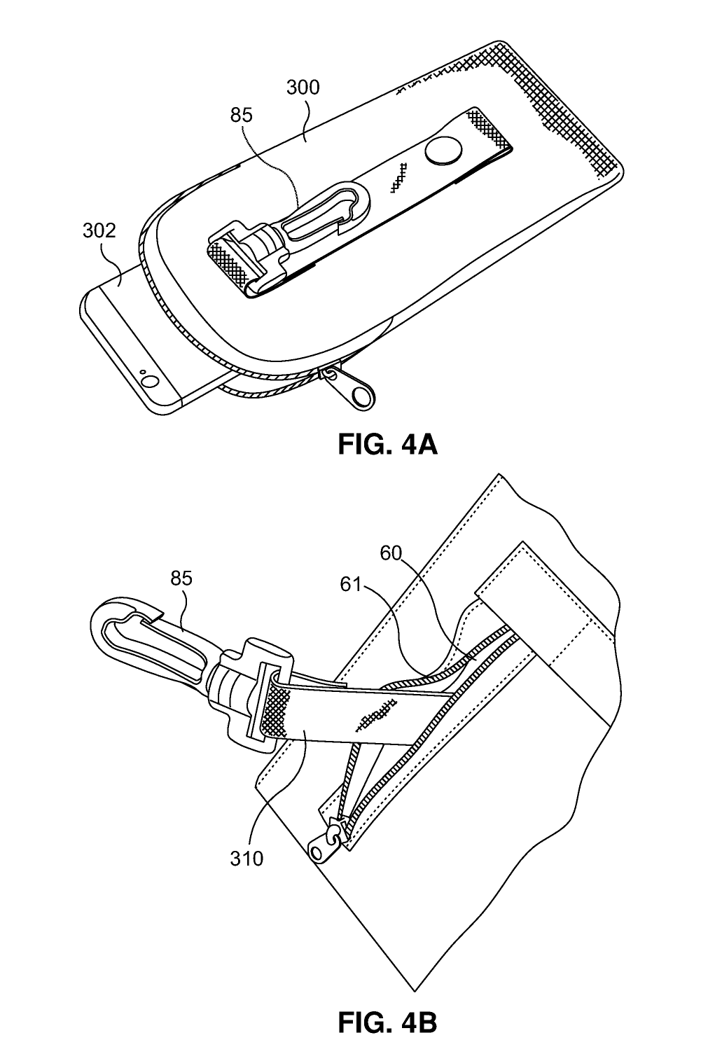

As mentioned the diaper bag can include several compartments 60, 70, 90. These compartments can be conveniently sized for such objects as diapers, wipes, towels, toys, wallets, cell phone, and virtually any accessory one might commonly wish to have on hand when using the diaper bag. Each compartment may also include a closure 61, 71, 91, for example a zipper type closure, to prevent objects from falling out of the compartments. Other types of closures such as snaps, hook and loop fasteners, buttons would also be suitable. In some embodiments, one or more of the compartments may be designed to be removable from the main body of the diaper bag. For example, a compartment may be attached to the main body via a zipper mechanism, thus allowing removal from the diaper bag by simply unzipping. Such a removable compartment might be convenient for storage of such things as cell phones, pagers and the like. For example, one can readily visualize how compartment 60 might be configured as a removable compartment. In other embodiments, removable compartments might be secured using hook and loop type fasteners for easy installation and removal. As shown in FIG. 4A still other detachable compartments may be secured to the diaper bag via a clip 85.

The diaper bag can also include loops 50, 80 configured that, in combination carabiner or clip-type attachments 85, can to reversibly secure objects to the outside of the bag for easy access. For example, toys, teething rings and like might be conveniently stored on the outside of the bag compartments for ease of access.

In some embodiments, it will be advantageous to provide straps whose length is independently adjustable. Such mechanisms for adjusting strap lengths are well known in the art, for example U.S. Pat. No. 121,992. All such straps are usable with the present diaper bag and are not considered to be limiting to the scope of the invention as claimed.

A variety of other features may be added to embodiments of the present disclosure. For example, it would be useful to include on the surface of the bag a photovoltaic charging device 82 that would convert solar energy into electrical energy for use in charging portable electronics. Thus, while walking outdoors during daylight hours, a user could take advantage of ambient sunlight to charge devices like cell phones or portable music devices.

In other embodiments, the bag might also include reflective tape to make it more visible when used at night. Those of skill in the art will appreciate that reflective tapes can be effectively placed in several locations on the surface of the bag. Alternatively, in some embodiments, the bag material itself might be made from a reflective material, or a material coated with a reflective coating, such that the entire bag will be readily visible at night.

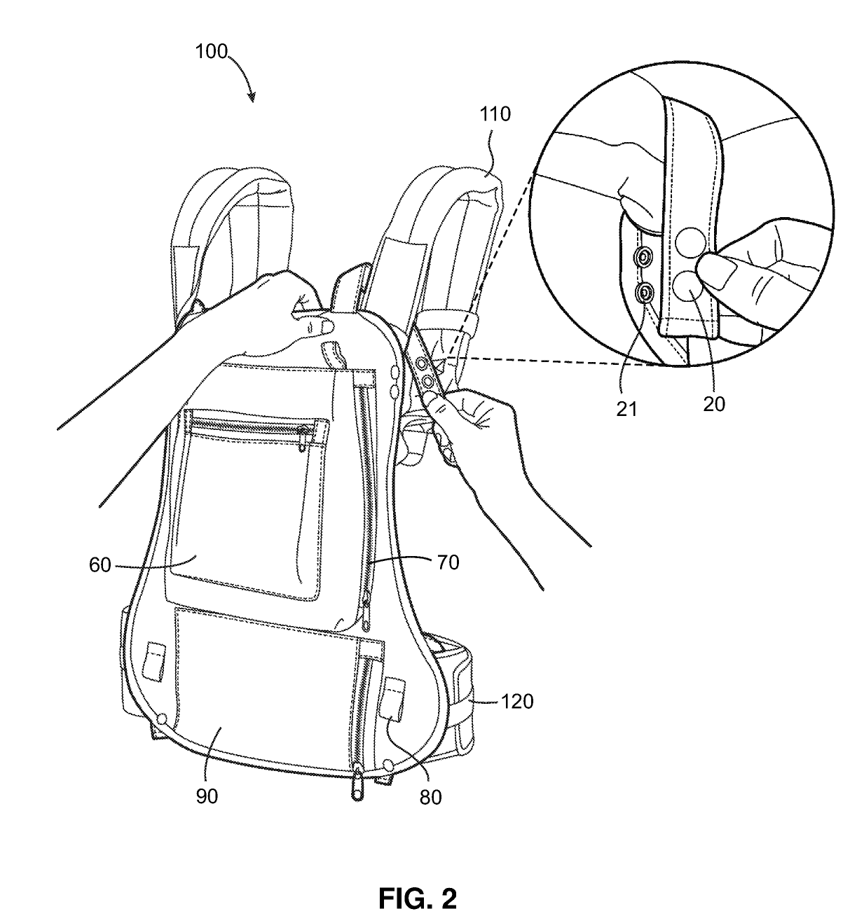

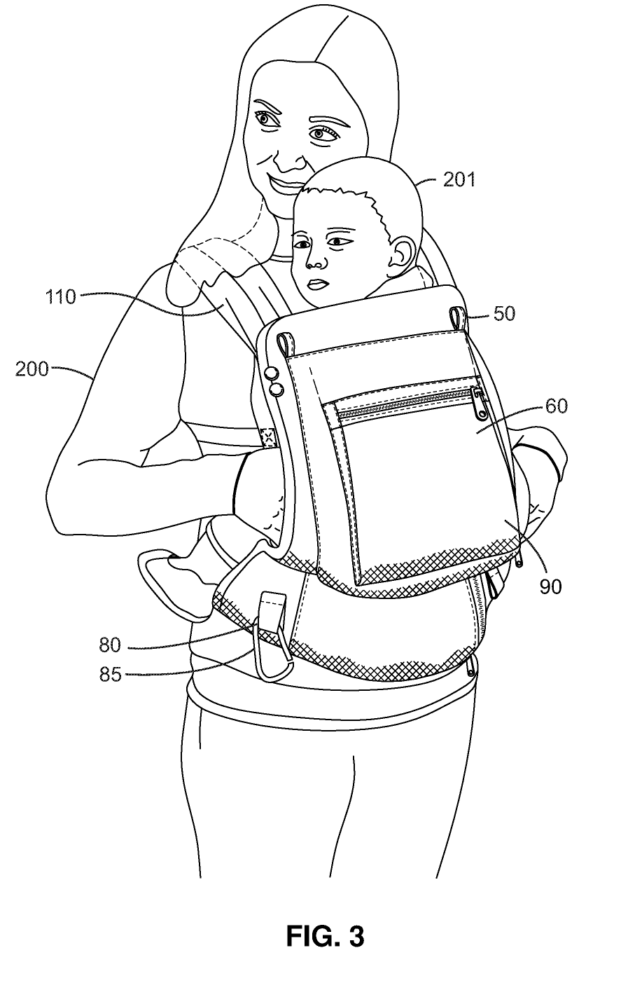

There is also provided a method for using the diaper bag as described herein in conjunction with a wearable infant carrier. For example, and as depicted in FIGS. 2 and 3, the four-point attachment system is secured to the infant carrier by looping each top strap around each shoulder strap 110 of a wearable infant carrier 100, and the bottom straps of the attachment system around the two portions of the waist strap 120 of such a carrier. The straps are secured in place by fasteners. For example, as shown in FIG. 2, male 20, 40 and female 21, 41 snap closures permit securement of the strap after it is looped around either shoulder straps 110 or waist strap 120 of the carrier. As indicated before, these fasteners may come in a variety of forms, including the depicted snaps, hook and loop closures, or slide type closures.

Once the diaper bag has been secured to the infant carrier, the infant carrier and attached diaper bag can now be placed on the user 200 and the infant 201 secured in the carrier. As shown in FIG. 3, the placement of the diaper bag on the carrier according to the present disclosure results in the various compartments being accessible to the user, without the need to remove the carrier or the diaper bag.

The bag can include several accessories. For example, as shown in FIG. 4A, a detachable compartment 300 can be attached via a clip 85 to one of the external loops 50, 80 on the bag. A cellphone 302 or other electronic device can conveniently be secured to the bag in this way, and then removed from the bag as needed without having to remove the bag from the wearer, or be easily accessed without to be removed from one of the integral bag compartments, according to the preference of the user.

In addition, as shown in FIG. 4B, in some embodiments a strap 310 can be secured within a compartment (for example compartment 60). This strap 310 can include a clip 85 that can conveniently be used to attach to a key ring. This allows the keys to be securely stored within a compartment of the bag to prevent inadvertent loss. In some cases, the clip can be secured to the interior of the compartment by a retractable cord mechanism, such that a key ring can be pulled from the bag for use without having to detach it from the clip structure, and then will automatically retract back into the storage compartment when released by the user.

The present invention is also adapted for easy storage. In some embodiments, to configure the bag for storage, one can open closure 61 to gain access to the interior of compartment 60. The compartment 60 can then be everted and the entire bag compacted into the everted (inside-out) compartment. The closure 61 can subsequently be closed, the bag now in a compact storage form. Those of skill in the art will appreciate the way in which the bag may be stored within a compartment by everting the compartment and stowing the bag within it. Similar techniques have been used in outerwear, where a jacket includes a pouch into which the jacket may be stowed, such as that described in U.S. Pat. No. 4,502,154 (Itoi).

The bag may be constructed from a variety of materials. Cloth, plastic, vinyl, and rubberized materials are all suitable for use in constructing the various components of the bag. In some embodiments, the body of the bag may include a radio frequency opaque lining that is operative to reduce radiation exposure to the infant, as well as to protect RFID-containing devices from unauthorized interrogation. As described above, the bag material may also include a reflective material to improve visibility at night, or such reflective material can be applied to the surface of the bag separately.

Conveniently, the bag is well adapted for use other than as a diaper bag. For example, it can be used as a beach bag, shopping bag, as an accessory for airplane beverage carts, hung from ladders or other structures as a tool carrier, or attached to wheelchairs, walkers, hospital beds and the like.

It should also be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A portable diaper bag comprising:
a main body comprising a plurality of compartments, each compartment comprising an opening to permit access to the interior of the compartment; and
a four-point attachment system comprising:
a top left strap, a top right strap, a bottom left strap and a bottom right strap, wherein the top left and top right straps are positioned on the main body such that they can each be reversibly secured to a shoulder strap of a wearable infant carrier, and wherein the bottom left and bottom right straps are position on the main body such that they can each be reversibly secured to a waist strap on the wearable infant carrier.

2. The diaper bag of claim 3, wherein each compartment further comprises a closure mechanism.

3. The diaper bag of claim 1, wherein each of the straps in the four-point attachment system comprises a fastener.

4. The diaper bag of claim 1, wherein the fastener comprises at least one of male and female snaps, male and female slide connectors, and a loop and hook fastening material.

5. The diaper bag of claim 1, wherein the length of each strap in the four-point attachment system is independently adjustable.

6. The diaper bag of claim 1, further comprising at least one loop on the exterior of the main body for attaching objects.

7. The diaper bag of claim 1, wherein the four-point attachment is configured such that each one of the straps can be fastened to any one of the other straps to form a at least one handle for carrying by hand.

8. The diaper bag of claim 1, further comprising a photovoltaic device configured to charge electronic devices.

9. The diaper bag of claim 1, wherein the diaper bag is invertable such that the bag can be foldable into one of the compartment for storage.

10. The diaper bag of claim 1, wherein the main body comprises a radio frequency opaque material.

11. The diaper bag of claim 10, wherein the radio frequency material is effective to protect interrogation of an RFID-containing device stored within the diaper bag.

12. The diaper bag of claim 1, wherein the bag further comprises a reflective material effective to improve visibility of the bag at night.

13. The diaper bag of claim 1, further comprising at least one detachable compartment.

14. A method of using a portable diaper bag, the method comprising:
providing a diaper bag, the diaper bag a main body comprising a plurality of compartments, each compartment comprising an opening to permit access to the interior of the compartment, wherein the diaper bag further comprises a four-point attachment system comprising:
a top left strap, a top right strap, a bottom left strap and a bottom right strap, wherein the top left and top right straps are positioned on the main body such that they can each be reversibly secured to a shoulder strap of a wearable infant carrier, and wherein the bottom left and bottom right straps are position on the main body such that they can each be reversibly secured to a waist strap on the wearable infant carrier;
providing a wearable infant carrier, the wearable infant carrier having a left shoulder strap, a right shoulder strap and a waist strap having a left portion and a right portion;
securing the top left strap to the left shoulder strap, the top right strap to the right shoulder strap, the bottom left strap to the left portion of the waist strap, and the bottom right strap to the right portion of the waist strap; and
placing the assembled diaper bag and wearable infant carrier on a user.
